(19) United States
(12) Patent Application Publication
(10) Pub. No.: US 2026/0001794 A1
(43) Pub. Date: Jan. 1, 2026

(54) INORGANIC-BIOHYBRID AND PREPARATION METHOD AND APPLICATION THEREOF

(71) Applicant: NANJING UNIVERSITY, Nanjing (CN)

(72) Inventors: Xuxiang ZHANG, Nanjing (CN); Wei ZHAO, Nanjing (CN); Junqing HOU, Nanjing (CN); Depeng WANG, Nanjing (CN); Kailong HUANG, Nanjing (CN)

(21) Appl. No.: 19/316,681

(22) Filed: Sep. 2, 2025

(30) Foreign Application Priority Data
Oct. 12, 2024 (CN) 202411420923.2

(51) Int. Cl. C02F 3/12; C02F 3/28; C02F 101/16

(52) U.S. Cl. CPC C02F 3/1268; C02F 3/1278; C02F 3/28; C02F 2101/16

(57) ABSTRACT

The present application discloses an inorganic-biohybrid and a preparation method and application thereof, and belongs to the technical field of wastewater treatment. The inorganic-biohybrid is obtained by hybridization of multi-walled carbon nanotubes and activated sludge derived from a denitrification biological filter. When being used in a hydrogen-based membrane bioreactor (H₂-MBfR) to perform denitrification of wastewater, the inorganic-biohybrid can be attached to a hollow fiber membrane to form a biofilm, so as to increase diffusion rates of H₂ and NO₃— in the biofilm, thereby effectively alleviating a dual-substrate diffusion limitation of H₂-MBfR, increasing an H₂ utilization rate thereof and reducing an explosion risk.

### TECHNICAL FIELD

The present application belongs to the technical field of wastewater treatment, and in particular, relates to an inorganic-biohybrid and a preparation method and application thereof.

### BACKGROUND

Nitrate nitrogen (NO₃—) is widely present in surface water and groundwater around the world. Heterotrophic denitrification is one of most commonly used technical means for removing NO₃— from water, mainly due to its high denitrification efficiency, low operating costs and simple operations. However, for wastewater with a low carbon-nitrogen ratio (C:N<4), an organic carbon source (such as acetate and methanol) needs to be supplemented to serve as an electron donor in the heterotrophic denitrification, leading to a sharp decrease in operation efficiency of a biochemical denitrification process, and resulting in residues of organic matters in the wastewater. Autotrophic denitrification, as a supplementary means to the heterotrophic denitrification, effectively avoids consumption of the organic carbon source, is compatible with the wastewater with the low carbon-nitrogen ratio, and broadens application scenarios of nitrogen removal by denitrification.

A hydrogen-based membrane bioreactor (H₂-MBfR) is an autotrophic denitrification technology that uses H₂ as the electron donor. H₂ is diffused to pass through a hollow fiber membrane in the membrane bioreactor to provide electrons for an autotrophic denitrification biofilm on the hollow fiber membrane in a bubble-free form, thereby achieving nitrogen removal by hydrogen-based autotrophic denitrification of the wastewater. Since the clean and green H₂ is used as the electron donor, H₂-MBfR not only avoids the problem of secondary pollution of effluent water, but also can significantly reduce indirect carbon emission in a denitrification process. However, NO₃— is diffused into the biofilm from an aqueous phase side, while H₂ is diffused into the biofilm from a hollow fiber membrane side, leading to a mismatch of substrate concentrations of H₂ and NO₃— in the biofilm. The mismatch of the substrate concentrations of H₂ and NO₃— on the biofilm decreases the H₂ utilization rate and increases the explosion risk. Therefore, how to achieve minimum loss of H₂ is one of key technical bottlenecks restricting wide applications of H₂-MBfR.

### SUMMARY

### 1. Problems to be Solved

To address problems such as a low H₂ utilization rate and a high explosion risk of a hydrogen-based membrane bioreactor in a denitrification process, the present application provides an inorganic-biohybrid and a preparation method and application thereof. The inorganic-biohybrid is obtained by hybridization of multi-walled carbon nanotubes and activated sludge derived from a denitrification biological filter. When being used in the hydrogen-based membrane bioreactor to perform denitrification of wastewater, the inorganic-biohybrid can be attached to a hollow fiber membrane to form a biofilm, so as to increase diffusion rates of H₂ and NO₃— in the biofilm, thereby effectively alleviating a dual-substrate diffusion limitation of H₂-MBfR, increasing an H₂ utilization rate thereof and reducing an explosion risk.

### 2. Technical Solutions

To solve the above problems, the present application adopts the following technical solutions.

In a first aspect, the present application provides an inorganic-biohybrid. The inorganic-biohybrid is obtained by hybridization of multi-walled carbon nanotubes (MWCNT) and activated sludge derived from a denitrification biological filter.

In a second aspect, the present application provides a preparation method of the above inorganic-biohybrid. The method includes the following steps:
S1: adding multi-walled carbon nanotubes (MWCNT) into N-methylpyrrolidone (NMP), and performing ultrasonic treatment to form a uniform MWCNT dispersion solution;
S2: adding activated sludge derived from a denitrification biological filter into the stirred MWCNT dispersion solution, and performing stirring for uniform mixing to form an inorganic-biohybrid precursor solution; and
S3: subjecting the inorganic-biohybrid precursor solution to standing for stratification, and removing supernatant to obtain the inorganic-biohybrid.

Further, in step S1, a time of the ultrasonic treatment is 2.0 to 6.0 h.

Further, in step S1, a concentration of the MWCNT dispersion solution is 0.1 to 1.0 g/L.

Further, in step S2, a mixed liquor suspended solid (MLSS) value of the activated sludge derived from the denitrification biological filter is 1.0 to 10 g/L.

Further, in step S2, a volume ratio of the MWCNT dispersion solution to the activated sludge is 1:0.1 to 1:10.

Further, in step S2, an adding speed of the activated sludge is 1.0 to 100 ml/min.

Further, in step S2, a time of the stirring for uniform mixing is 5.0 to 30 min.

Further, in step S3, a standing time is 10 to 60 min.

In a third aspect, the present application provides application of the above inorganic-biohybrid or the preparation method thereof in denitrification of wastewater.

Further, the above application is to utilize the inorganic-biohybrid to enhance a hydrogen-based membrane bioreactor to perform denitrification of wastewater. Specifically, the inorganic-biohybrid is attached to a hollow fiber membrane to form a biofilm, and the formed biofilm can increase diffusion rates of H₂ and NO₃— in the biofilm, thereby effectively alleviating a dual-substrate diffusion limitation of H₂-MBfR and increasing an H₂ utilization rate thereof.

Further, the above wastewater is wastewater with a low carbon-nitrogen ratio.

Further, a concentration of nitrate nitrogen in the above wastewater with the low carbon-nitrogen ratio is 15 to 200 mg/L.

Further, the carbon-nitrogen ratio of the above wastewater with the low carbon-nitrogen ratio is 0:1 to 4:1.

Further, the above application includes the following steps:
M1: pumping an inorganic-biohybrid dispersion solution into a membrane bioreactor;
M2: loading the inorganic-biohybrid onto the hollow fiber membrane by suction filtration on a hollow fiber membrane assembly of the membrane bioreactor, where the inorganic-biohybrid can be attached to the hollow fiber membrane to form the biofilm, so as to increase the diffusion rates of H₂ and NO₃— in the biofilm, thereby effectively alleviating the dual-substrate diffusion limitation of H₂-MBfR and achieving the effect of increasing the H₂ utilization rate thereof;
M3: introducing a nutrient solution into the membrane bioreactor, and introducing hydrogen into the hollow fiber membrane to perform acclimation on the inorganic-biohybrid; and
M4: after the acclimation is completed, pumping the wastewater into the membrane bioreactor to perform nitrogen removal by denitrification.

Further, in step M1, a preparation method of the inorganic-biohybrid dispersion solution includes: adding a culture solution into the inorganic-biohybrid for cleaning, and then mixing the inorganic-biohybrid with the culture solution after the cleaning to form the inorganic-biohybrid dispersion solution.

Further, a formula of the above culture solution includes 1.0 g/L of sodium acetate, 50 mM of a phosphate buffer solution, 5 ml/L of a vitamin solution, and 12.5 ml/L of a trace mineral solution.

Further, a concentration of the above inorganic-biohybrid dispersion solution is 1.0 to 10 g/L.

Further, the above cleaning is performed for 1 to 5 times. Furthermore, the cleaning is performed for 3 times.

Further, in step M2, the hollow fiber membrane assembly is a hollow fiber membrane filament made of polypropylene, and the membrane filament has an effective length of 10 to 20 cm, an outer diameter of 100 to 500 μm, and a membrane pore size of 0.01 to 0.45 μm.

Further, in step M3, a formula of the nutrient solution includes 50 mM of the phosphate buffer solution, 5 ml/L of the vitamin solution, and 12.5 ml/L of the trace mineral solution.

Further, in step M3, a flow rate of the hydrogen is 0.01 to 1 ml/min.

Further, in step M3, an acclimation time is 3 to 7 days.

Further, in step M4, a hydraulic retention time of the wastewater with the low carbon-nitrogen ratio is 6.0 to 24 h.

In a fourth aspect, the present application provides a method for denitrification of wastewater with a low carbon-nitrogen ratio, which specifically includes:
N1: pumping the above inorganic-biohybrid dispersion solution into a membrane bioreactor;
N2: loading the inorganic-biohybrid onto the hollow fiber membrane by suction filtration on a hollow fiber membrane assembly of the membrane bioreactor, where the inorganic-biohybrid can be attached to the hollow fiber membrane to form the biofilm, so as to increase the diffusion rates of H₂ and NO₃— in the biofilm, thereby effectively alleviating the dual-substrate diffusion limitation of H₂-MBfR and achieving the effect of increasing the H₂ utilization rate thereof;
N3: introducing a nutrient solution into the membrane bioreactor, and introducing hydrogen into the hollow fiber membrane to perform acclimation on the inorganic-biohybrid; and
N4: after the acclimation is completed, pumping the wastewater into the membrane bioreactor to perform nitrogen removal by denitrification.

Further, a concentration of nitrate nitrogen in the above wastewater with the low carbon-nitrogen ratio is 15 to 200 mg/L.

Further, the carbon-nitrogen ratio of the above wastewater with the low carbon-nitrogen ratio is 0:1 to 4:1.

Further, in step N1, a preparation method of the inorganic-biohybrid dispersion solution includes: adding a culture solution into the inorganic-biohybrid for cleaning, and then mixing the inorganic-biohybrid with the culture solution after the cleaning to form the inorganic-biohybrid dispersion solution. Further, a formula of the above culture solution includes 1.0 g/L of sodium acetate, 50 mM of a phosphate buffer solution, 5 ml/L of a vitamin solution, and 12.5 ml/L of a trace mineral solution.

Further, a concentration of the above inorganic-biohybrid dispersion solution is 1.0 to 10 g/L.

Further, the above cleaning is performed for 1 to 5 times. Furthermore, the cleaning is performed for 3 times.

Further, in step N2, the hollow fiber membrane assembly is a hollow fiber membrane filament made of polypropylene, and the membrane filament has an effective length of 10 to 20 cm, an outer diameter of 100 to 500 μm, and a membrane pore size of 0.01 to 0.45 μm.

Further, in step N3, a formula of the nutrient solution includes 50 mM of the phosphate buffer solution, 5 ml/L of the vitamin solution, and 12.5 ml/L of the trace mineral solution.

Further, in step N3, a flow rate of the hydrogen is 0.01 to 1 ml/min.

Further, in step N3, an acclimation time is 3 to 7 days.

Further, in step N4, a hydraulic retention time of the wastewater with the low carbon-nitrogen ratio is 6.0 to 24 h.

### 3. Beneficial Effects

Compared with the prior art, the present application has the following beneficial effects.

According to the inorganic-biohybrid and the preparation method and application thereof provided by the present application, the inorganic-biohybrid is obtained by the hybridization of the multi-walled carbon nanotubes and the activated sludge derived from the denitrification biological filter. When being used for enhancing the hydrogen-based membrane bioreactor to perform denitrification of wastewater, the inorganic-biohybrid is attached to the hollow fiber membrane to form the biofilm, which can significantly increase the H₂ utilization rate of H₂-MBfR and achieve the H₂ utilization rate of ≥80%. Meanwhile, under treatment of wastewater of a same volume, H₂-MBfR can decrease an H₂ supply quantity by 50%.

### BRIEF DESCRIPTION OF THE DRAWINGS

FIG. 1 shows SEM images, in which (a) is an SEM image of traditional activated sludge; and (b) is an SEM image of an inorganic-biohybrid prepared in Example 1.

FIG. 2 is a schematic structural diagram of an inorganic-biohybrid enhanced hydrogen-based membrane bioreactor (H₂-MBfR).

FIG. 3 shows denitrification rates and H₂ utilization rates of a traditional hydrogen-based membrane bioreactor and an inorganic-biohybrid enhanced hydrogen-based membrane bioreactor.

FIG. 4 shows denitrification rates and H₂ utilization rates of a traditional hydrogen-based membrane bioreactor and an inorganic-biohybrid enhanced hydrogen-based membrane bioreactor.

### DETAILED DESCRIPTION

The present application is further described below in conjunction with specific examples.

Unless otherwise defined, all technical terms and scientific terms used herein have the same meanings as generally understood by those skilled in the art to which the present application belongs; and the term “and/or” as used herein includes any and all combinations of one or more related listed items.

Those without specific conditions in the examples are used in accordance with conventional conditions or conditions recommended by manufacturers. All reagents or instruments used without specific manufacturers are conventional products that can be purchased on the market.

Concentrations, quantities, and other numerical value data can be presented in the form of a range herein. It should be understood that the form of a range is used only for convenience and brevity, and should be interpreted flexibly to include not only numerical values that are explicitly stated as limits of the range, but also all individual numerical values or subranges that are covered within the range, as if each numerical value and subrange are explicitly stated.

### Example 1

The present example provides an inorganic-biohybrid and a preparation method thereof.

The inorganic-biohybrid was obtained by hybridization of multi-walled carbon nanotubes (MWCNT) and activated sludge derived from a denitrification biological filter. The preparation method included the following steps:
(1) 1.0 g of the multi-walled carbon nanotubes (MWCNT, Aladdin, C139872) were added into 1.0 L of N-methylpyrrolidone (NMP), and ultrasonic treatment was performed for 6.0 h to form a 1.0 g/L uniform MWCNT dispersion solution;
(2) 1.0 L of the 1.0 g/L activated sludge derived from the denitrification biological filter (from Nanjing Jiangxinzhou sewage treatment plant) was added into the stirred MWCNT dispersion solution at an adding speed of 100 mL/min, and stirring for uniform mixing was performed for 10 min to form 2.0 L of an inorganic-biohybrid precursor solution; and
(3) the inorganic-biohybrid precursor solution was subjected to standing for 20 min for stratification, and supernatant was removed by centrifugation at 3000 rpm to obtain the inorganic-biohybrid.

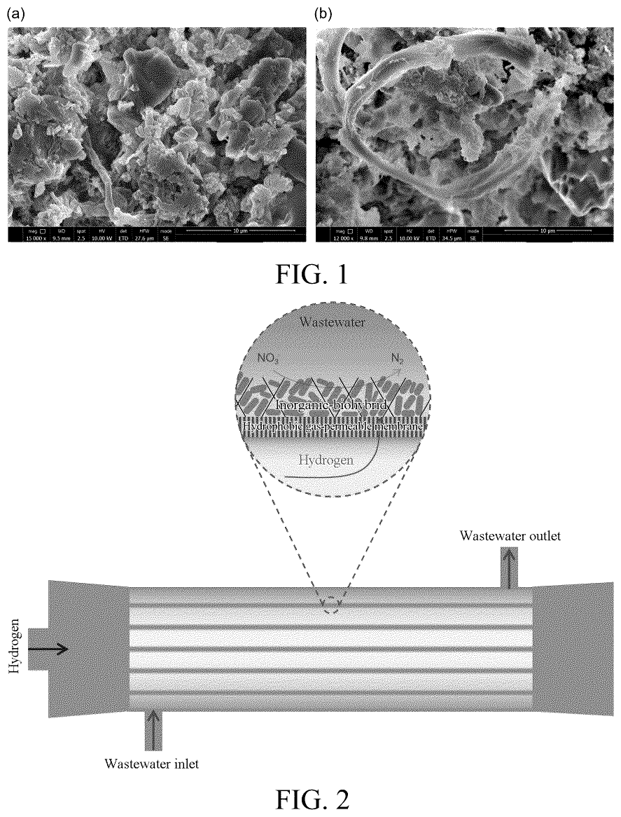

An SEM image of the inorganic-biohybrid prepared in the present example is shown in FIG. 1, in which (a) is an SEM image of traditional activated sludge, and (b) is the SEM image of the inorganic-biohybrid prepared in Example 1, and it indicates that the inorganic-biohybrid is formed by compounding of the MWCNT and the activated sludge.

### Example 2

The present example provides application of an inorganic-biohybrid in denitrification of wastewater.

In the present example, the application was to utilize the inorganic-biohybrid to enhance a hydrogen-based membrane bioreactor to perform the denitrification of the wastewater. A structure principle of the inorganic-biohybrid enhanced hydrogen-based membrane bioreactor (H₂-MBfR) is shown in FIG. 2. Specifically, the inorganic-biohybrid was attached to a hollow fiber membrane to form a biofilm, and the formed biofilm could increase diffusion rates of H₂ and NO₃— in the biofilm, thereby effectively alleviating a dual-substrate diffusion limitation of H₂-MBfR and increasing an H₂ utilization rate thereof.

In the present example, the used H₂-MBfR included a hollow fiber membrane assembly made of polypropylene, where membrane filaments had an effective length of 10 to 20 cm, an outer diameter of 100 to 500 μm, and a membrane pore size of 0.01 to 0.45 μm, and the hollow fiber membrane filaments had a quantity of 80 pieces and a total effective area of 100 cm².

### Example 3

The present example provides application of an inorganic-biohybrid in denitrification of wastewater.

In the present example, the application was that the inorganic-biohybrid was enabled to be attached to a hollow fiber membrane to form a biofilm, and the inorganic-biohybrid was utilized to enhance a hydrogen-based membrane bioreactor to perform the denitrification of the wastewater, which specifically included the following steps:
(1) a culture solution (formula of the culture solution: 1.0 g/L of sodium acetate, 50 mM of a phosphate buffer solution, 5 ml/L of a vitamin solution, and 12.5 ml/L of a trace mineral solution) was added into the inorganic-biohybrid to perform cleaning for 3 times; then 1.0 L of the culture solution was added and mixing was performed to form a 2.0 g/L inorganic-biohybrid dispersion solution; and 1.0 L of the 2.0 g/L inorganic-biohybrid dispersion solution was pumped into H₂-MBfR, and then the inorganic-biohybrid was loaded onto the hollow fiber membrane by means of suction filtration;
(2) a nutrient solution (formula of the nutrient solution: 1.0 g/L of sodium acetate, 50 mM of the phosphate buffer solution, 5 ml/L of the vitamin solution, and 12.5 ml/L of the trace mineral solution) was pumped into H₂-MBfR, and at the same time, H₂ was introduced into the hollow fiber membrane to perform acclimation on the inorganic-biohybrid on the hollow fiber membrane for 7 days; and
(3) wastewater with a low carbon-nitrogen ratio (a concentration of nitrate nitrogen was 70 mg/L, and the carbon-nitrogen ratio was 2.6) was pumped into H₂-MBfR, and at the same time, H₂ was introduced into the hollow fiber membrane to carry out a denitrification experiment, where a hydraulic retention time of the wastewater was controlled at 6.0 h based on a pump speed, and a flow rate of the hydrogen was controlled at 0.4 mL/min by a gas flowmeter.

A denitrification rate was calculated by testing concentrations of the nitrate nitrogen in effluent water of H₂-MBfR at different times. An H₂ utilization rate was calculated by testing concentrations of H₂ in gas emitted from H₂-MBfR at different times.

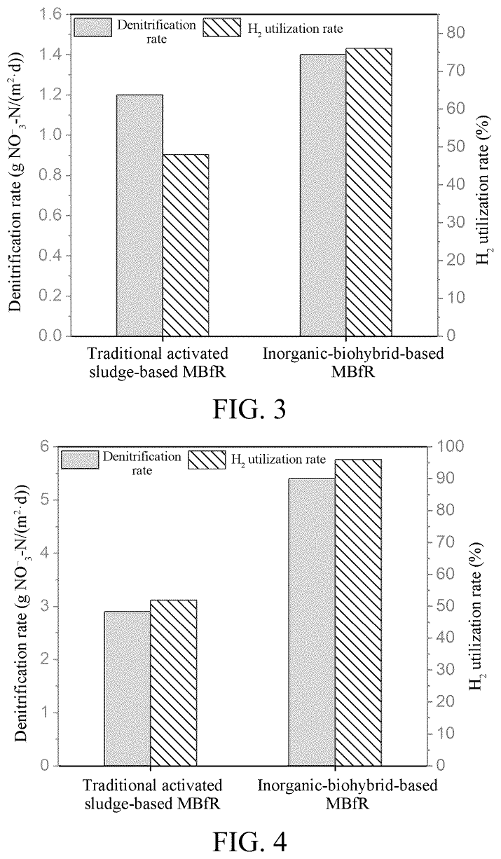

Results are shown in FIG. 3. Traditional activated sludge-based H₂-MBfR has a denitrification rate of about 1.2 g/(m²d) and an H₂ utilization rate of 48%. The inorganic-biohybrid-based H₂-MBfR of the present invention has a denitrification rate of about 1.4 g/(m²d) and an H₂ utilization rate of 76%. Therefore, compared with the traditional activated sludge-based H₂-MBfR, the denitrification rate of the inorganic-biohybrid-based H₂-MBfR of the present invention is increased by 17%, and the H₂ utilization rate is increased by 58%.

### Example 4

The present example provides application of an inorganic-biohybrid in denitrification of wastewater.

In the present example, the application was that the inorganic-biohybrid was enabled to be attached to a hollow fiber membrane to form a biofilm, and the inorganic-biohybrid was utilized to enhance a hydrogen-based membrane bioreactor to perform the denitrification of the wastewater, which specifically included the following steps:
(1) a culture solution (formula of the culture solution: 1.0 g/L of sodium acetate, 50 mM of a phosphate buffer solution, 5 ml/L of a vitamin solution, and 12.5 ml/L of a trace mineral solution) was added into the inorganic-biohybrid to perform cleaning for 3 times; then 1.0 L of the culture solution was added and mixing was performed to form a 2.0 g/L inorganic-biohybrid dispersion solution; and 1.0 L of the 2.0 g/L inorganic-biohybrid dispersion solution was pumped into H₂-MBfR, and then the inorganic-biohybrid was loaded onto the hollow fiber membrane by means of suction filtration;
(2) a nutrient solution (formula of the nutrient solution: 1.0 g/L of sodium acetate, 50 mM of the phosphate buffer solution, 5 ml/L of the vitamin solution, and 12.5 ml/L of the trace mineral solution) was pumped into H₂-MBfR, and at the same time, H₂ was introduced into the hollow fiber membrane to perform acclimation on the inorganic-biohybrid on the hollow fiber membrane for 7 days; and
(3) wastewater with a low carbon-nitrogen ratio (a concentration of nitrate nitrogen was 140 mg/L, and the carbon-nitrogen ratio was 2.6) was pumped into H₂-MBfR, and at the same time, H₂ was introduced into the hollow fiber membrane to carry out a denitrification experiment, where a hydraulic retention time of the wastewater was controlled at 8.0 h based on a pump speed, and a flow rate of the hydrogen was controlled at 0.6 ml/min by a gas flowmeter.

A denitrification rate was calculated by testing concentrations of the nitrate nitrogen in effluent water of H₂-MBfR at different times. An H₂ utilization rate was calculated by testing concentrations of H₂ in gas emitted from H₂-MBfR at different times.

Results are shown in FIG. 4. Traditional activated sludge-based H₂-MBfR has a denitrification rate of about 2.9 g/(m²d) and an H₂ utilization rate of 52%. The inorganic-biohybrid-based H₂-MBfR of the present invention has a denitrification rate of about 5.4 g/(m²d) and an H₂ utilization rate of 96%, which is almost completely utilized. Therefore, compared with the traditional activated sludge-based H₂-MBfR, the denitrification rate of the inorganic-biohybrid-based H₂-MBfR of the present invention is increased by 36%, and the H₂ utilization rate is increased by 85%.

What is claimed is:

1. Application of an inorganic-biohybrid in denitrification of wastewater, wherein the application is to utilize the inorganic-biohybrid to enhance a hydrogen-based membrane bioreactor to perform the denitrification of the wastewater;
the inorganic-biohybrid is obtained by hybridization of multi-walled carbon nanotubes and activated sludge derived from a denitrification biological filter; and
a preparation method of the inorganic-biohybrid comprises the following steps:
S1: adding the multi-walled carbon nanotubes into N-methylpyrrolidone, and performing ultrasonic treatment to form a uniform multi-walled carbon nanotube dispersion solution;
S2: adding the activated sludge derived from the denitrification biological filter into the stirred multi-walled carbon nanotube dispersion solution, and performing stirring for uniform mixing to form an inorganic-biohybrid precursor solution; and
S3: subjecting the inorganic-biohybrid precursor solution to standing for stratification, and removing supernatant to obtain the inorganic-biohybrid.

2. The application according to claim 1, wherein
a concentration of the multi-walled carbon nanotube dispersion solution is 0.1 to 1.0 g/L; and/or
a mixed liquor suspended solid (MLSS) value of the activated sludge derived from the denitrification biological filter is 1.0 to 10 g/L; and/or
a volume ratio of the multi-walled carbon nanotube dispersion solution to the activated sludge is 1:0.1 to 1:10.

3. The application according to claim 2, wherein
in step S1, a time of the ultrasonic treatment is 2.0 to 6.0 h; and/or
in step S2, an adding speed of the activated sludge is 1.0 to 100 mL/min; and/or
in step S2, a time of the stirring for uniform mixing is 5.0 to 30 min; and/or
in step S3, a standing time is 10 to 60 min.

4. The application according to claim 3, wherein the wastewater is wastewater with a low carbon-nitrogen ratio.

5. The application according to claim 3 or 4, wherein the application comprises the following steps:
M1: pumping the inorganic-biohybrid dispersion solution into the membrane bioreactor;
M2: loading the inorganic-biohybrid onto the hollow fiber membrane by suction filtration on a hollow fiber membrane assembly of the membrane bioreactor, wherein the inorganic-biohybrid is attached to a hollow fiber membrane to form a biofilm;
M3: introducing a nutrient solution into the membrane bioreactor, and introducing hydrogen into the hollow fiber membrane to perform acclimation on the inorganic-biohybrid, wherein a formula of the nutrient solution comprises 50 mM of a phosphate buffer solution, 5 ml/L of a vitamin solution, and 12.5 ml/L of a trace mineral solution; and
M4: after the acclimation is completed, pumping the wastewater into the membrane bioreactor to perform nitrogen removal by denitrification.

6. The application according to claim 5, wherein
a concentration of the inorganic-biohybrid dispersion solution is 1.0 to 10 g/L; a preparation method of the inorganic-biohybrid dispersion solution comprises: adding a culture solution into the inorganic-biohybrid for cleaning, and then mixing the inorganic-biohybrid with the culture solution after the cleaning to form the inorganic-biohybrid dispersion solution; and a formula of the culture solution comprises 1.0 g/L of sodium acetate, 50 mM of the phosphate buffer solution, 5 ml/L of the vitamin solution, and 12.5 ml/L of the trace mineral solution.

7. The application according to claim 6, wherein
a flow rate of the hydrogen is 0.01 to 1 mL/min; and/or
an acclimation time is 3 to 7 days; and/or
a hydraulic retention time of the wastewater is 6.0 to 24 h.

8. A method for denitrification of wastewater with a low carbon-nitrogen ratio, comprising the following steps:
N1: pumping the inorganic-biohybrid dispersion solution of the inorganic-biohybrid according to claim 1 into a membrane bioreactor;
N2: loading the inorganic-biohybrid onto the hollow fiber membrane by suction filtration on a hollow fiber membrane assembly of the membrane bioreactor, wherein the inorganic-biohybrid is attached to a hollow fiber membrane to form a biofilm;
N3: introducing a nutrient solution into the membrane bioreactor, and introducing hydrogen into the hollow fiber membrane to perform acclimation on the inorganic-biohybrid, wherein a formula of the nutrient solution comprises 50 mM of a phosphate buffer solution, 5 ml/L of a vitamin solution, and 12.5 ml/L of a trace mineral solution; and
N4: after the acclimation is completed, pumping the wastewater into the membrane bioreactor to perform nitrogen removal by denitrification.

9. The method according to claim 8, wherein
a concentration of the inorganic-biohybrid dispersion solution is 1.0 to 10 g/L; a preparation method of the inorganic-biohybrid dispersion solution comprises: adding a culture solution into the inorganic-biohybrid for cleaning, and then mixing the inorganic-biohybrid with the culture solution after the cleaning to form the inorganic-biohybrid dispersion solution; and a formula of the culture solution comprises 1.0 g/L of sodium acetate, 50 mM of the phosphate buffer solution, 5 ml/L of the vitamin solution, and 12.5 ml/L of the trace mineral solution.

10. The method according to claim 9, wherein
a flow rate of the hydrogen is 0.01 to 1 mL/min; and/or
an acclimation time is 3 to 7 days; and/or
a hydraulic retention time of the wastewater is 6.0 to 24 h.
